(19) United States
(12) Patent Application Publication
(10) Pub. No.: US 2018/0003834 A1
(43) Pub. Date: Jan. 4, 2018

(54) PRESSURE COMPENSATION FOR A MARINE VIBRATOR

(71) Applicant: PGS Geophysical AS, Oslo (NO)

(72) Inventor: Stig Rune Lennart TENGHAMN, Houston, TX (US)

(21) Appl. No.: 15/491,819

(22) Filed: Apr. 19, 2017

Related U.S. Application Data
(60) Provisional application No. 62/356,230, filed on Jun. 29, 2016.

(51) Int. Cl. G01V 1/137; G01V 13/00; G01V 1/38

(52) U.S. Cl. CPC G01V 1/137; G01V 1/3843; G01V 13/00

(57) ABSTRACT

A marine vibrator assembly includes a vibrational source; a hose connectable between the vibrational source and a gas source; and a releasable coupling between the hose and the vibrational source. A method of operating a marine vibrator assembly includes deploying a vibrational source into a body of water at a first depth, wherein an internal pressure of the vibrational source balances an external pressure on the vibrational source at the first depth; supplying gas at a flow rate to an interior of the vibrational source from a gas source as the vibrational source moves from the first depth to a second depth, wherein the internal pressure of the vibrational source balances the external pressure on the vibrational source at the second depth; stopping the supplying the gas from the gas source.

### CROSS REFERENCE TO RELATED APPLICATIONS

This application claims benefit of U.S. Provisional Patent Application Ser. No. 62/356,230, filed Jun. 29, 2016, entitled “Pressure Compensation for a Low Frequency Source,” which is incorporated herein by reference.

### BACKGROUND OF THE INVENTION

This disclosure is related generally to the field of marine surveying. Marine surveying can include, for example, seismic and/or electromagnetic surveying, among others. For example, this disclosure may have applications in marine surveying, in which one or more source elements are used to generate wave-fields, and sensors—either towed or ocean bottom—receive energy generated by the source elements and affected by the interaction with the subsurface formation. The sensors thereby collect survey data which can be useful in the discovery and/or extraction of hydrocarbons from subsurface formations.

Seismic sources are generally devices that generate acoustic energy. Many marine seismic sources are of the impulsive type, which generate a large amount of energy during a short time span. Commonly used impulsive-type sources include air guns, explosives, and weight-drop impulse sources. Another type of marine seismic sources includes marine vibrators, such as hydraulically powered sources, electro-mechanical vibrators, electrical marine seismic vibrators, and sources employing piezoelectric or magnetostrictive material.

Prior marine vibrators have typically been designed for relatively high-frequency operation (e.g., above 10 Hz). However, as seismic waves travel through water and through subsurface geological structures, higher frequency seismic waves may be attenuated more rapidly than lower frequency seismic waves, and consequently, lower frequency seismic waves can be transmitted over longer distances through water and geological structures than can higher frequency seismic waves. Thus, efforts have been undertaken to develop seismic sources that can operate at lower frequencies. Very low frequency sources (“VLFS”) have been developed that typically have at least one resonance frequency of about 10 Hz or lower. VLFS are typically characterized by having a source size that is very small as compared to a wavelength of seismic for the VLFS. The source size for a VLFS is typically much less than 1/10th of a wavelength and more typically on the order of 1/100th of a wavelength. For example, a source with a maximum dimension of 3 meters operating at 5 Hz is 1/100th of a wavelength in size.

In order to achieve a given level of output in the water, a marine vibrator may undergo a change in volume. In order to work at depth while minimizing structural weight, the marine vibrator may be pressure balanced with external hydrostatic pressure. As the internal gas (e.g., air) in the marine vibrator increases in pressure, the bulk modulus (or “stiffness”) of the internal gas also rises. Increasing the bulk modulus of the internal gas also increases the air-spring effect within the marine vibrator. As used herein, the term “air-spring” is defined as an enclosed volume of gas that may absorb shock or fluctuations of load due to the ability of the enclosed volume of gas to resist compression and decompression. Increasing the stiffness of the gas in the enclosed volume increases the air-spring effect, and thus the ability of the enclosed volume of gas to resist compression and decompression. This increase in the air-spring effect of the internal gas tends to be a function of the operating depth of the source. Further, the stiffness of the acoustic components of the marine vibrator and the internal gas are the primary determining factors in the marine vibrator's resonance frequency. Accordingly, the resonance frequency generated by the marine vibrator may undesirably increase when the marine vibrator is towed at depth, especially in marine vibrators where the interior volume of the marine vibrator may be pressure balanced with the external hydrostatic pressure. New methods and devices for pressure compensation for very low frequency sources would be helpful.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates attenuation of source strength for a source at 10 meters depth.

FIG. 2 illustrates attenuation of source strength for a source at 100 meters depth.

FIG. 3 illustrates an example of a VLFS suitable for use as a vibrational source of this disclosure.

FIG. 4 illustrates an example of a VLFS suitable for use as a vibrational source of this disclosure.

FIG. 5 illustrates an embodiment of a marine vibrator assembly.

FIG. 6 illustrates another embodiment of a marine vibrator assembly.

FIG. 7 illustrates another embodiment of a marine vibrator assembly.

FIG. 8 illustrates another embodiment of a marine vibrator assembly.

FIG. 9 illustrates another embodiment of a marine vibrator assembly.

FIG. 10 illustrates a method of operating a marine vibrator assembly.

### DETAILED DESCRIPTION

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected, in close proximity or at a distance. The term “attached” means directly or indirectly connected in close proximity. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +−10% variation. The term “nominal” means as planned or designed in the absence of variables such as wind, waves, currents, or other unplanned phenomena. “Nominal” may be implied as commonly used in the field of marine surveying.

“Cable” shall mean a flexible, axial load carrying member that also comprises electrical conductors and/or optical conductors for carrying electrical power and/or signals between components. “Rope” shall mean a flexible, axial load carrying member that does not include electrical and/or optical conductors. Such a rope may be made from fiber, steel, other high strength material, chain, or combinations of such materials. “Line” shall mean either a rope or a cable. “Forward” or “front” shall mean the direction or end of an object or system that corresponds to the intended primary direction of travel of the object or system. “Aft” or “back” shall mean the direction or end of an object or system that corresponds to the reverse of the intended primary direction of travel of the object or system. “Obtaining” data shall mean any method or combination of methods of acquiring, collecting, or accessing data, including, for example, directly measuring or sensing a physical property, receiving transmitted data, selecting data from a group of physical sensors, identifying data in a data record, and retrieving data from one or more data libraries. If there is any conflict in the usages of a word or term in this specification and one or more patent or other documents that may be incorporated herein by reference, the definitions that are consistent with this specification should be adopted for the purposes of understanding this invention.

The present invention generally relates to marine seismic surveying methods and apparatuses, and, at least in some embodiments, to novel pressure compensation equipment for marine vibrators, and their associated methods of use.

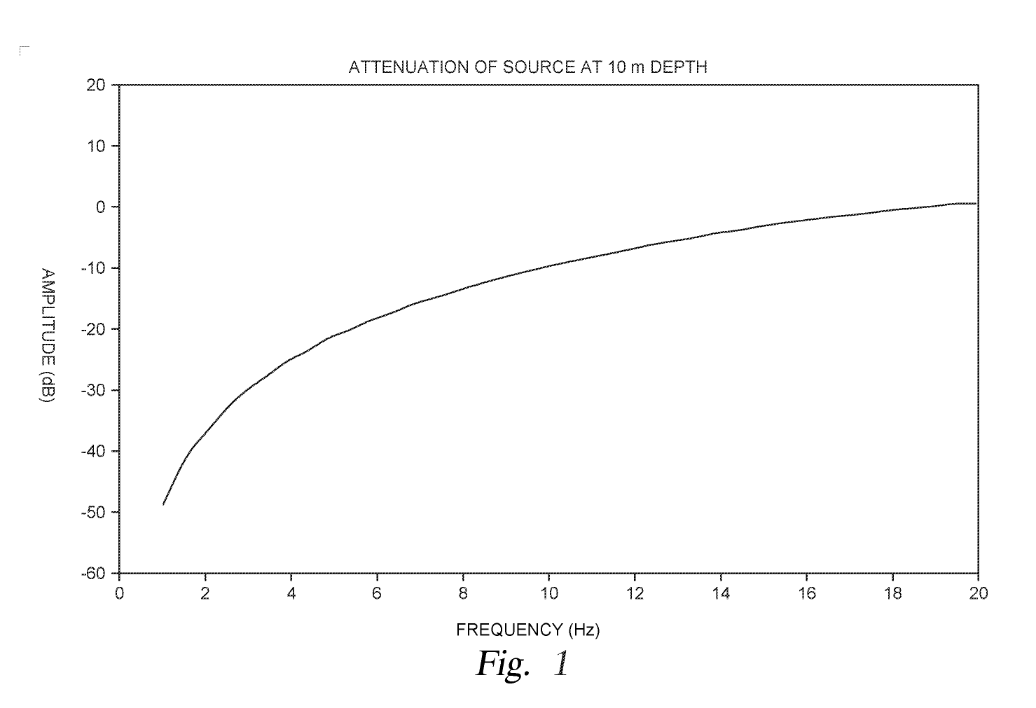

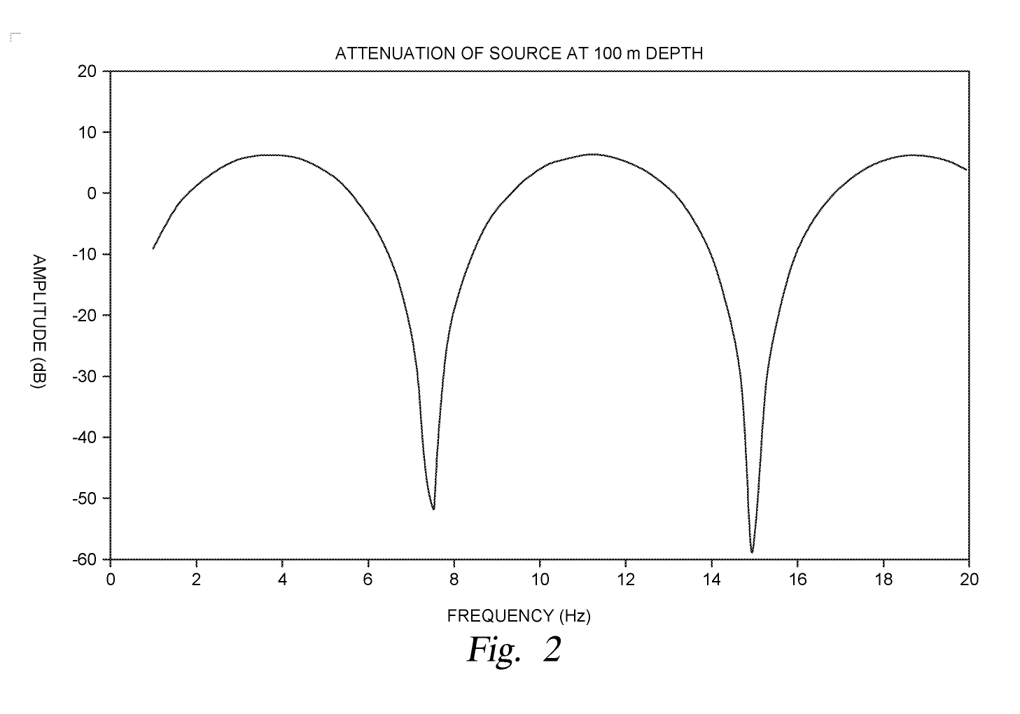

At least one embodiment of the present disclosure can improve acoustic output of marine vibrators, and more specifically very low frequency sources (“VLFS”), used for a data acquisition system that includes a marine vibrator assembly. At least one embodiment of the present disclosure can include a vibrational source having a sound emitting surface adapted to be excited into vibrational motion. The sound emitting surface can be used, for example, in seismic prospecting. VLFS with high amplitude can be beneficial for seismic acquisition. For example, at least one benefit can include an improvement to seismic inversion methods. Some previous inversion methods can be constrained by missing low frequencies. Low frequency information can help stabilize full wavefield inversion (“FWI”) methods. The improvement to seismic inversion methods can include imaging beneath complex geology. At least one benefit can include longer wavelengths transmitted through complex geologies that strongly scatter frequencies in a conventional band. The wavelengths can be used to image underlying geology. At least one benefit can include improvements to image resolution by reducing wavelet side lobes. At least one benefit can include deep imaging by reducing alternation of low frequency seismic waves that allows imaging deeper geology. As can be seen in FIGS. 1 and 2, towing seismic sources close to the surface may attenuate much of the low frequency energy.

By towing a seismic source deeper, attenuation of the low frequency can be avoided. Towing a marine vibrator deep can cause an air-spring effect when the interior gas is compressed. For example, a low frequency operation bandwidth can use high amplitudes, about +/−100 millimeters to reach 200 decibels at 2.5 hertz (Hz) with a surface area of 8 square meters. For a source operating from 1-5 Hz, a depth of the source could be from 50-200 meters to make use of the surface reflection to boost the acoustic output.

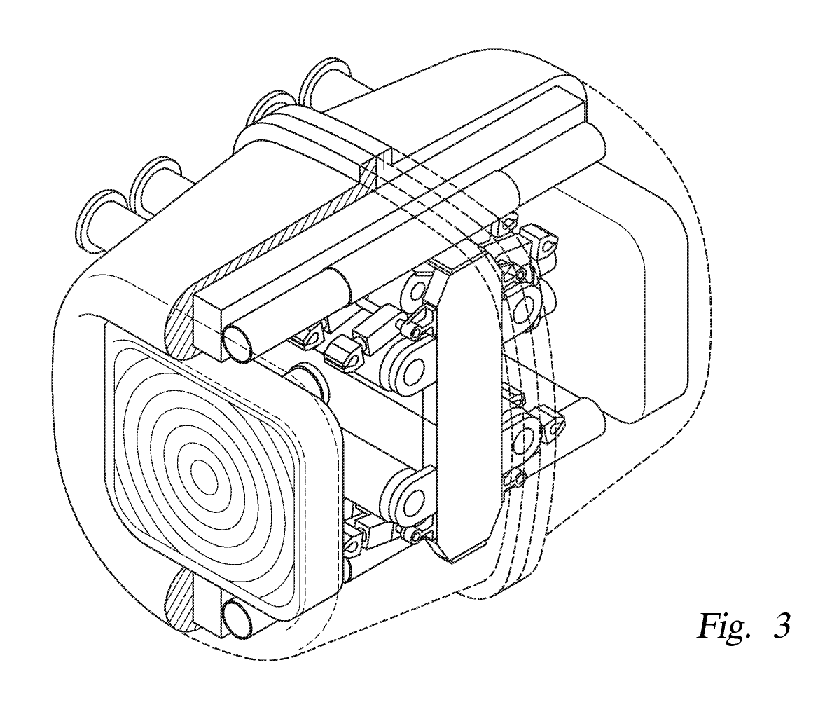

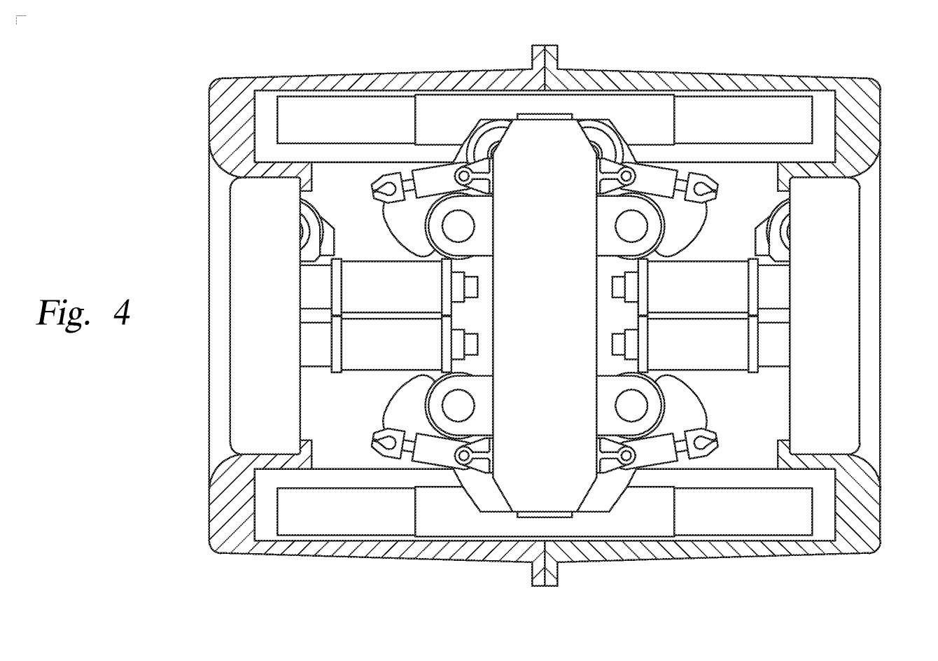

FIGS. 3 and 4 illustrate an example of a VLFS suitable for use as a vibrational source of this disclosure. The illustrated VLFS has two pistons and a driver mechanism based on linear motors. The two pistons create two vibrational surfaces on opposite sides of the VLFS. During operation, the vibrational source may be towed so that the vibrational surfaces vibrate in a direction perpendicular to the towing direction. In some embodiments, the vibrational source may be towed so that the vibrational surfaces vibrate in a direction perpendicular to the towing direction and to the surface of the body of water.

Towing the vibrational source deep means that increased external pressure on the vibrational source generated by water depth may need to be compensated for in the interior of the source. For example, to tow the vibrational source at 100 meter depth, a compensation of 10 bar over atmospheric pressure is used. Further, compressed gas source with 200 bar pressure can be attached to the source and equalize the pressure when the source is deployed.

When the volume of the vibrational source is 5 cubic meters and the depth is 100 meters, a volume of 5*10/200 cubic meters in the compressed gas sources may be used. This is 0.25 cubic meters. Extra gas may be used to compensate for depth variations, etc. For example, at least 0.5 to 1 cubic meter of compressed air can be used. This may make the marine vibrator assembly more heavy and complex. Using an umbilical cable with an air hose may not be a good solution since the diameter of the umbilical cable can increase, causing the drag to increase when the marine vibrator assembly is being towed.

At least one embodiment of the present disclosure includes using a hose, separate from the umbilical, that is connectable to the vibrational source. The hose can be used when the vibrational source is lowered to its operating depth. When the vibrational source has reached its operating depth, the hose can be released from the vibrational source by a remotely-operated mechanism. The hose may then be retrieved out of the body of water. The hose can be used instead of, or in addition to, compressed gas sources attached to the marine vibrator assembly. Using the hose can reduce the weight and/or complexity of the marine vibrator assembly during marine survey operations. Once the hose has been released, this may have a negligible impact upon drag during towing of the marine vibrator assembly. Embodiments of the present disclosure can thereby be useful in the discovery and/or extraction of hydrocarbons from subsurface formations.

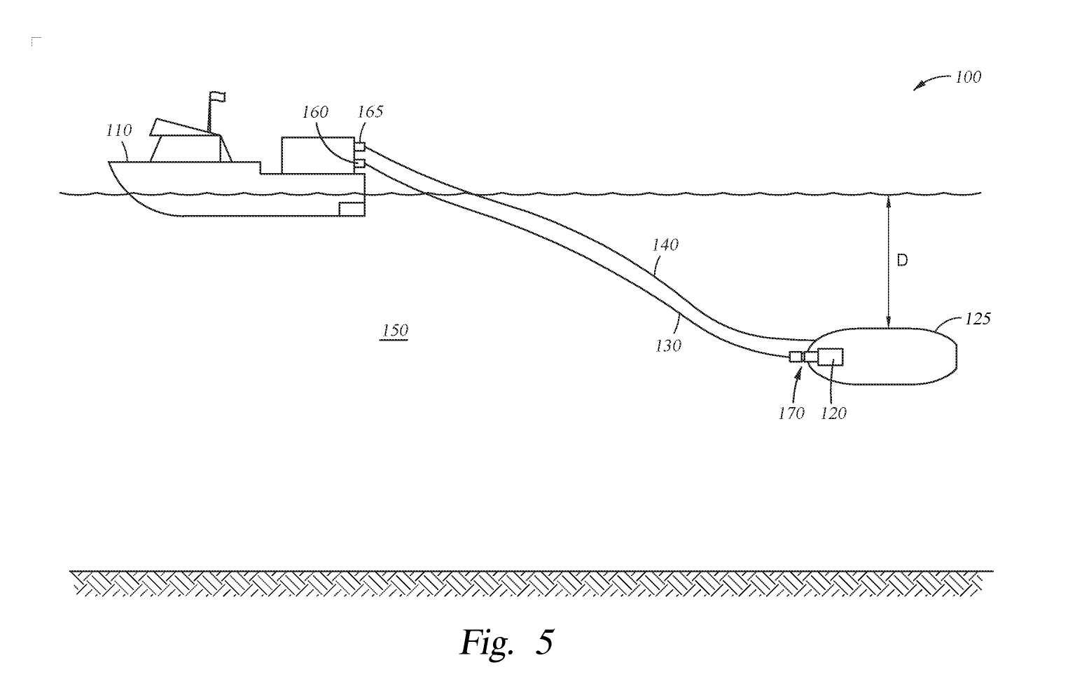

FIG. 5 illustrates a marine vibrator assembly 100. The marine vibrator assembly includes a vibrational source 120 connectable to a hose 130, which is coupled to a gas source, such as surface gas source 160 on survey vessel 110. Hose 130 may provide gas communication between surface gas source 160 and vibrational source 120. As illustrated, survey vessel 110 tows vibrational source 120 through a body of water 150 at a depth D. The vibrational source 120 may be contained in a housing 125. For example, vibrational source 120 may be contained in a tow fish. Housing 125 may be configured to take advantage of hydrodynamics to reduce drag, reduce spin, and maintain orientation. Housing 125 may contain vibrational source 120 by at least partially surrounding vibrational source 120. Vibrational source 120 is connectable to hose 130 with a releasable coupling 170. As used herein, “connectable” means having the ability to couple and decouple without degrading the functionality of the system. Releasable coupling 170 may couple vibrational source 120 and hose 130 to provide gas flow therebetween. When vibrational source 120 is contained within housing 125, releasable coupling 170 may be external to housing 125, internal to housing 125, or partially internal and partially external to housing 125. Vibrational source 120 may also be coupled to umbilical 140, which is coupled to a recording system 165 on survey vessel 110. In some embodiments, recording system 165 may include equipment that may provide and/or include navigation control, navigation monitoring, including position determination, source control, source monitoring, receiver control, receiver monitoring, survey data recording, time monitoring, and/or time synchronization between the various control, monitoring, and/or recording elements. Umbilical 140 may provide electrical, optical, hydraulic, and/or other communication channels between vibrational source 120 and the recording system 165. For example, umbilical 140 may facilitate transmission of sensor data and/or control signals between vibrational source 120 and the recording system 165. In some embodiments, umbilical 140 may convey the towing force from survey vessel 110 to vibrational source 120, while in other embodiments a separate cable or rope may be utilized for that purpose. For simplicity, other equipment common to marine survey operations has been omitted, including, for example, source cables, lead-in lines, spreader cables, streamer array, etc.

In some embodiments, hose 130 may have a relatively small diameter. For example, hose 130 may have a diameter of about 2 inches, between 1 inch and 2 inches, about 1 inch, or less than about 1 inch. Hose 130 having a relatively small diameter may reduce towing weight and/or drag. An appropriate hose 130 may be selected based on operational considerations. For example, cost and availability of the gas may be important. In some embodiments, hoses used for seismic air guns may be retrofitted and repurposed to be used as hose 130 as disclosed herein. The depth D at which vibrational source 120 is towed determines, at least in part, an appropriate length of hose 130. In some embodiments, the length of hose 130 may be about 300 meters, between about 300 meters and about 600 meters, about 600 meters, or greater than 600 meters. Hose 130 may be configured to deliver high pressure gas from a gas source to vibrational source 120. For example, hose 130 may be configured to deliver gas at a pressure of about 100 bar, between 100 bar and 200 bar, about 200 bar, or greater than about 200 bar. In some embodiments, hose 130 may be configured to deliver gas at a flow rate of about 0.0025 m³/s, between 0.0025 m³/s and 0.005 m³/s, about 0.005 m³/s, or greater than 0.005 m³/s.

In some embodiments, surface gas source 160 may be a source of gas at atmospheric pressure. For example, surface gas source 160 may be an air compressor, a pump, a compressed gas tank, or a combination thereof. Surface gas source 160 may flow gas into hose 130. In some embodiments, the gas may be air, oxygen, nitrogen, an inert gas, a low-adiabatic index gas, or a combination thereof. An appropriate gas may be selected based on operational considerations. For example, cost and availability of the gas may be important. Storage of the gas onboard survey vessel 110 may call for a non-volatile gas that is easily stored with minimal safety concerns. Locating surface gas source 160 onboard survey vessel 110, rather than in the body of water 150, may reduce towing weight and/or drag. However, operational considerations may lead some embodiments to locate surface gas source 160 near or at the surface of body of water 150, while not onboard survey vessel 110. For example, surface gas source 160 may be in, or towed by, a separate vessel, other than survey vessel 110. Surface gas source 160 may be configured to deliver high pressure gas to hose 130. For example, hose 130 may be configured to deliver gas at a pressure of about 100 bar, between 100 bar and 200 bar, about 200 bar, or greater than about 200 bar.

During operation, vibrational source 120 in housing 125 may be deployed from survey vessel 110 into body of water 150. Survey vessel 110 may move through body of water 150 while vibrational source 120 is being deployed. Vibrational source 120 may initially be at a first depth D₁ in the body of water 150. For example, the vibrational source 120 may be deployed near the surface, at a depth of less than about 3 meters, at a depth between about 3 meters and about 10 meters, or at a depth of less than about 10 meters. A first external pressure acts on vibrational source 120, wherein the external pressure may increase as a function of depth. At the first depth D₁, vibrational source 120 may have a first resonance frequency. As the operation continues, vibrational source 120 may move to a deeper, second depth D₂. For example, the vibrational source 120 may move to a depth of about 50 meters, to a depth of between about 50 meters and about 100 meters, to a depth of about 100 meters, or to a depth of greater than about 100 meters. The vibrational source 120 may move between first depth D₁ and second depth D₂ by sinking from its own weight, by the use of depth control devices coupled to housing 125, by the use of motorized equipment (e.g., an autonomous underwater vehicle), or by any other mechanism capable of initiating, contributing to, maintaining, and/or controlling depth change. The second depth D₂ may be selected to be the operational depth for vibrational source 120. In other words, it may be desired to actuate vibrational source 120 at second depth D₂ to generate acoustic energy as part of a marine survey. Sensors attached to vibrational source 120 and/or housing 125 may detect the depth of vibrational source 120, and the depth information may be relayed to recording system 165 for better controlling the depth change. At second depth D₂, a second external pressure acts on vibrational source 120, and vibrational source 120 may have a second resonance frequency.

The rate at which vibrational source 120 descends from depth D₁ to depth D₂ may vary. As would be understood by one of ordinary skill in the art with the benefit of this disclosure, a rapid change of depth may cause a rapid change in external pressure on vibrational source 120. In the event that pressure compensation, such as provided by surface gas source 160 through hose 130, is not sufficiently rapid to offset the external pressure change, the mechanical structure of vibrational source 120 (e.g., seals) may be compromised. Therefore, in some embodiments, the rate of descent may be limited to be less than about 0.5 meters/second, less than about 0.2 meters/second, or less than about 0.1 meters/second. However, during descent of vibrational source 120 from depth D₁ to depth D₂, towing speed may be slow (e.g., less than about 3 knots), and/or survey data may not be collected, resulting in increasing survey costs as the time of descent increases. Therefore, in some embodiments, the rate of descent may be selected to be as fast as possible given the availability of pressure compensation to offset the external pressure change. In some embodiments, a compressed gas source may be used in addition to surface gas source 160 to provide additional pressure compensation availability.

Hose 130 may be used with a gas source to balance the internal pressure of the vibrational source 120 with the external pressure on the vibrational source 120 at one or more depths. As used herein, internal and external pressures “balance” at a relevant depth when the internal pressure is substantially the same as the external, hydrostatic pressure at that depth. In order to mitigate leak concerns, the internal pressure may be as high as 110% of the external pressure and still be “balanced.” The internal pressure may be as low as 95% of the external pressure and still be “balanced.” In some embodiments, hose 130 may convey gas from the gas source to vibrational source 120 at first depth D₁ to balance the internal pressure of the vibrational source 120 with the external pressure on the vibrational source 120. In some embodiments, hose 130 may convey gas from the gas source to vibrational source 120 at second depth D₂ to balance the internal pressure of the vibrational source 120 with the external pressure on the vibrational source 120. In some embodiments, hose 130 may convey gas from the gas source to vibrational source 120 at one or more depths between first depth D₁ and second depth D₂ to balance the internal pressure of the vibrational source 120 with the external pressure on the vibrational source 120. In some embodiments, hose 130 may convey gas from the gas source to vibrational source 120 while the vibrational source 120 moves from first depth D₁ to the second depth D₂ to balance the internal pressure of the vibrational source 120 with the external pressure on the vibrational source 120. In some embodiments, with vibrational source 120 at one or more depths, hose 130 may convey gas from vibrational source 120 to the gas source to balance the internal pressure of the vibrational source 120 with the external pressure on the vibrational source 120. The gas source thereby acts as a gas reservoir.

In some embodiments, the marine vibrator assembly 100 may include one or more pressure sensors. For example, a pressure sensor may measure the internal pressure of vibrational source 120. As another example, a pressure sensor may measure the external pressure on vibrational source 120. In some embodiments, the marine vibrator assembly 100 may include one or more gas flow regulators which may be paired with a pump or pair of pumps. For example, a gas flow regulator may regulate gas flow between hose 130 and vibrational source 120. In some embodiments, a gas flow regulator may be responsive to measurements made by one or more pressure sensors. For example, a gas flow regulator between hose 130 and vibrational source 120 may allow gas to flow (or may pump gas) from hose 130 to the interior of vibrational source 120 until the internal pressure of the vibrational source 120 balances with the external pressure on the vibrational source 120. In some embodiments, a pressure sensor may measure the internal pressure of vibrational source 120 as the vibrational source 120 descends from depth D₁ to depth D₂. The pressure measurements may be communicated to the recording system for recording, analyzing, and/or processing to generate a control signal. The recording system may send a control signal to a gas flow regulator based on a pressure measurement. In some embodiments, pressure measurements may be communicated directly from a pressure sensor to a gas flow regulator without contacting and/or utilizing the recording system.

Hose 130 may be released from vibrational source 120 without degrading the functionality of the system. For example, after the internal pressure of the vibrational source 120 is balanced with the external pressure on the vibrational source 120 at an operational depth, for example depth D₂, hose 130 may be released from vibrational source 120. Vibrational source 120 may be connectable to hose 130 with a releasable coupling 170. Once hose 130 has been released from vibrational source 120, releasable coupling 170 may seal to prevent water intrusion into vibrational source 120. Likewise, releasable coupling 170 may seal to prevent gas escape from vibrational source 120. Releasable coupling 170 may be activated remotely to release hose 130. For example, releasable coupling 170 may include a signal receiver for receiving a “release” control signal. The signal receiver may receive a control signal from electrical, optical, hydraulic, mechanical, and/or other communication channels. The control signal may be generated onboard survey vessel 110, for example from recording system 165. The control signal may be locally generated, for example in response to a threshold measurement by a depth sensor attached to the vibrational source 120. In some embodiments, a depth sensor attached to vibrational source 120 may be mechanically, electrically, hydraulically, or otherwise integrated with releasable coupling 170 so that the depth sensor triggers the release of hose 130 without an intervening control signal. In some embodiments, the functionality of the depth sensor may be provided by a hydrostatic pressure sensor, since the external pressure may increase as a function of depth.

Following release of hose 130, the speed at which survey vessel moves through the body of water 150 may be increased (e.g., between about 3 knots and about 4 knots). As would be understood by one of ordinary skill in the art with the benefit of this disclosure, the depth of the vibrational source 120 in the body of water 150 while being towed by survey vessel 110 may decrease (become more shallow) as the speed of towing increases. Consequently, in order to balance the internal pressure of the vibrational source 120 with the external pressure on the vibrational source 120 at the decreased depth, gas may be removed from the interior of vibrational source 120. A pressure sensor may measure the internal pressure of the vibrational source 120. A gas flow regulator may allow gas to flow (or may pump gas) out of the vibrational source 120. In some embodiments, the gas flow regulator may allow gas to flow (or may pump gas) from the vibrational source 120 to a gas reservoir attached to the vibrational source 120.

Following release of hose 130, pressure compensation for vibrational source 120 may be provided by one or more compressed gas sources attached to vibrational source 120 (not illustrated). In some embodiments, a gas flow regulator between a compressed gas source and vibrational source 120 may regulate the flow of gas from compressed gas source to the interior of vibrational source 120. In some embodiments, the gas flow regulator between the compressed gas source and the vibrational source 120 may be responsive to measurements from one or more pressure sensors. Gas may flow from the compressed gas source to the vibrational source 120, or gas may flow from the vibrational source 120 to the compressed gas source. The compressed gas source may thereby act as a gas reservoir.

Following release of hose 130, the hose 130 may be retrieved, for example onboard survey vessel 110. Following the retrieval of hose 130, the speed at which survey vessel moves through the body of water 150 may be increased (e.g., greater than about 4 knots).

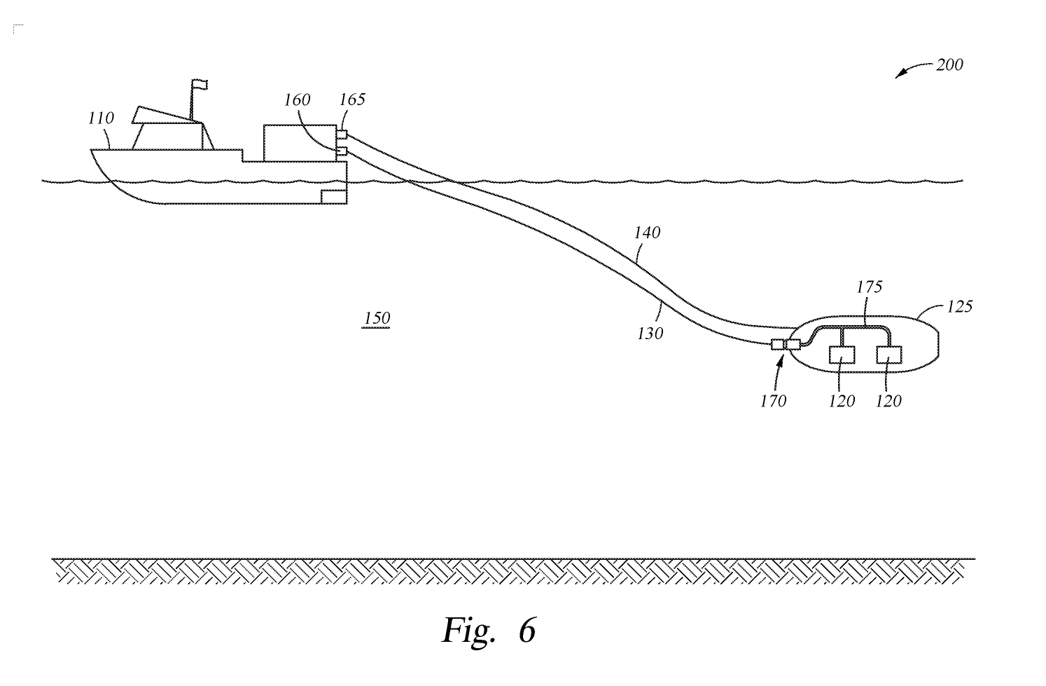

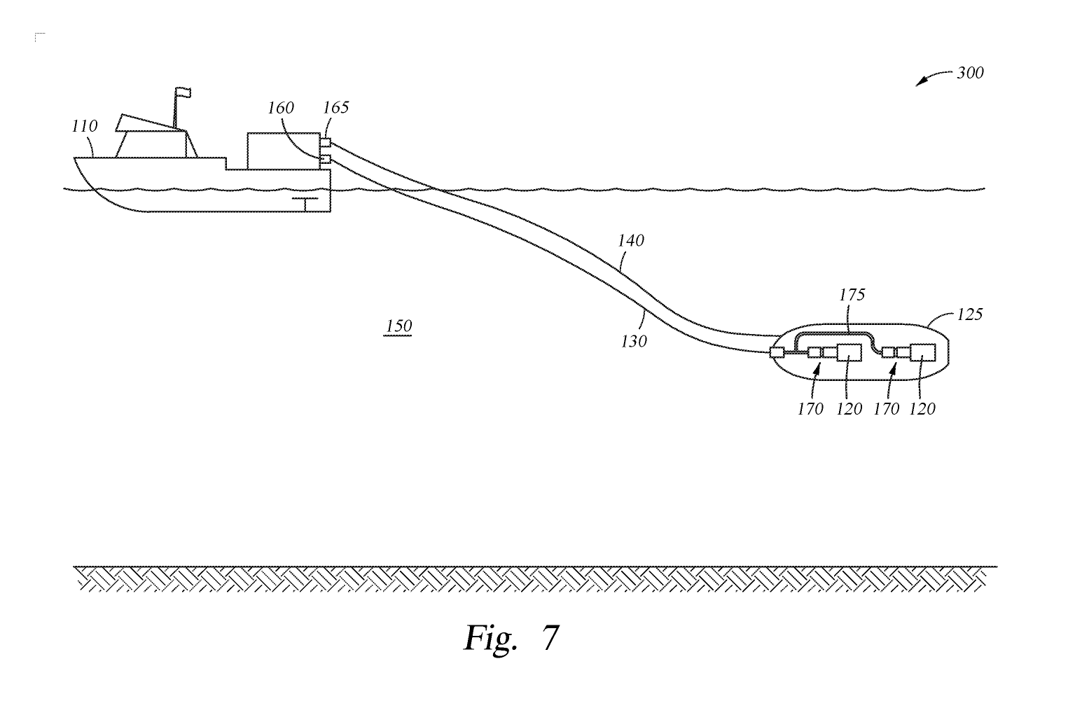

FIGS. 6 and 7 illustrate marine vibrator assemblies 200 and 300, respectively. As illustrated, marine vibrator assemblies 200 and 300 are configured similarly to marine vibrator assembly 100. However, housing 125 contains two vibrational sources 120. In some embodiments, housing 125 may contain one, two, three, four, or more vibrational sources 120. The vibrational sources 120 may have the same or different internal volumes and/or structures. A manifold 175 may provide a gas coupling between any two or more of the vibrational sources 120 contained within housing 125. Housing 125 may contain manifold 175 by at least partially surrounding manifold 175. In some embodiments, manifold 175 may be integrated with housing 125. For example, a wall of housing 125 may have one or more hollow bores configured to provide gas flow between any two or more vibrational sources 120 contained within the housing 125. In some embodiments, manifold 175 may be at least partially external to housing 125. In some embodiments, each vibrational source 120 is contained within its own housing 125, and manifold 175 may be at least partially external to one or both of the housings 125. As illustrated in FIG. 6, the hose 130 is connectable to the manifold 175 with a single releasable coupling 170. As illustrated in FIG. 7, the manifold 175 is connectable to each of the vibrational sources 120 with a separate releasable coupling 170. To facilitate release of hose 130 in the embodiment illustrated in FIG. 7, housing 125 may be configured to release and/or eject manifold 175. Likewise, manifold 175 may be external to housing 125. In some embodiments, both the coupling between the manifold and the hose, and the couplings between the manifold and each of the vibrational sources may have a releasable coupling.

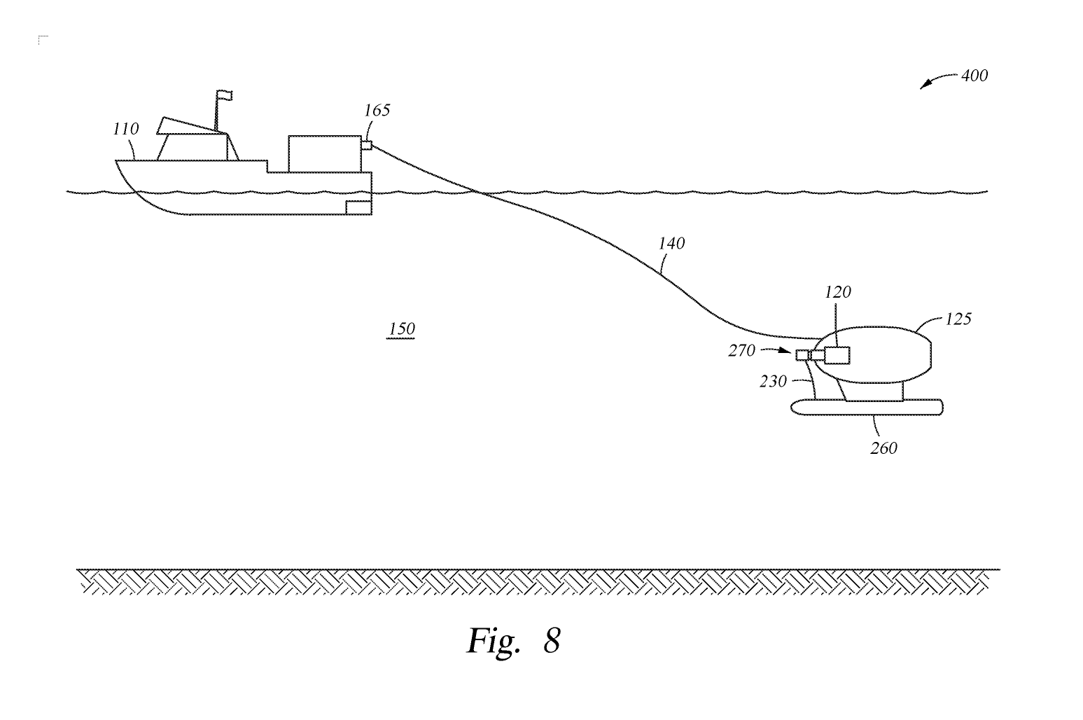

FIG. 8 illustrates marine vibrator assembly 400. As illustrated, marine vibrator assembly 400 is configured similarly to marine vibrator assembly 100. However, instead of surface gas source 160, hose 230 is coupled to compressed gas source 260. Compressed gas source 260 may be configured to deliver high pressure gas to hose 230. For example, compressed gas source 260 may be configured to deliver gas at a pressure of about 100 bar, between 100 bar and 200 bar, about 200 bar, or greater than about 200 bar. As illustrated, compressed gas source 260 is attached to vibrational source 120, for example, securely fastened to the outside of housing 125. In some embodiments, compressed gas source 260 may be attached to vibrational source 120 by being contained within housing 125. Housing 125 may contain compressed gas source 260 by at least partially surrounding compressed gas source 260. Hose 230 and releasable coupling 270 may similarly be reconfigured to accommodate attachment of compressed gas source 260 while still providing a releasable coupling between hose 230 and vibrational source 120. In some embodiments, a gas flow regulator between hose 230 and vibrational source 120 may regulate the flow of gas from compressed gas source 260, through hose 230, to the interior of vibrational source 120. In some embodiments, the gas flow regulator between hose 230 and vibrational source 120 may be responsive to measurements from one or more pressure sensors. In some embodiments, the attachment between compressed gas source 260 and vibrational source 120 may be releasable. When both the releasable coupling 270 with hose 230 and the releasable attachment with compressed gas source 260 have been released, compressed gas source 260 (with accompanying hose 230) may separate from the remainder of the marine vibrator assembly 400. For example, the compressed gas source 260 may be abandoned in the body of water 150, or the compressed gas source 260 may be retrieved from the body of water 150.

In some embodiments, a surface gas source 160 may be coupled to a first hose 130, which is connectable to vibrational source 120, and a compressed gas source 260, attached to vibrational source 120, may be coupled to a second hose 230, which is connectable to the vibrational source 120. The vibrational source 120 may be connectable to the first hose 130 with a first releasable coupling 170, and the vibrational source 120 may be connectable to the second hose 230 with a second releasable coupling 270. In some embodiments, the first hose 130 couples to the second hose 230, so that both the first hose 130 and the second hose 230 are connectable to the vibrational source 120 with a single releasable coupling. In some embodiments, wherein first releasable coupling 170 is separate from second releasable coupling 270, first hose 130 may be released separately from second hose 230. For example, both surface gas source 160 and compressed gas source 260 may provide pressure compensation until a particular criterion is met (e.g., depth of vibrational source 120). At that time, first releasable coupling 170 may release hose 130, while compressed gas source 260 remains coupled to vibrational source 120 through second hose 230. When another criterion is met (e.g., internal pressure of vibrational source 120), second releasable coupling 270 may release hose 230. In some embodiments, the hose coupled to the compressed gas source may be released prior to the hose coupled to the surface gas source.

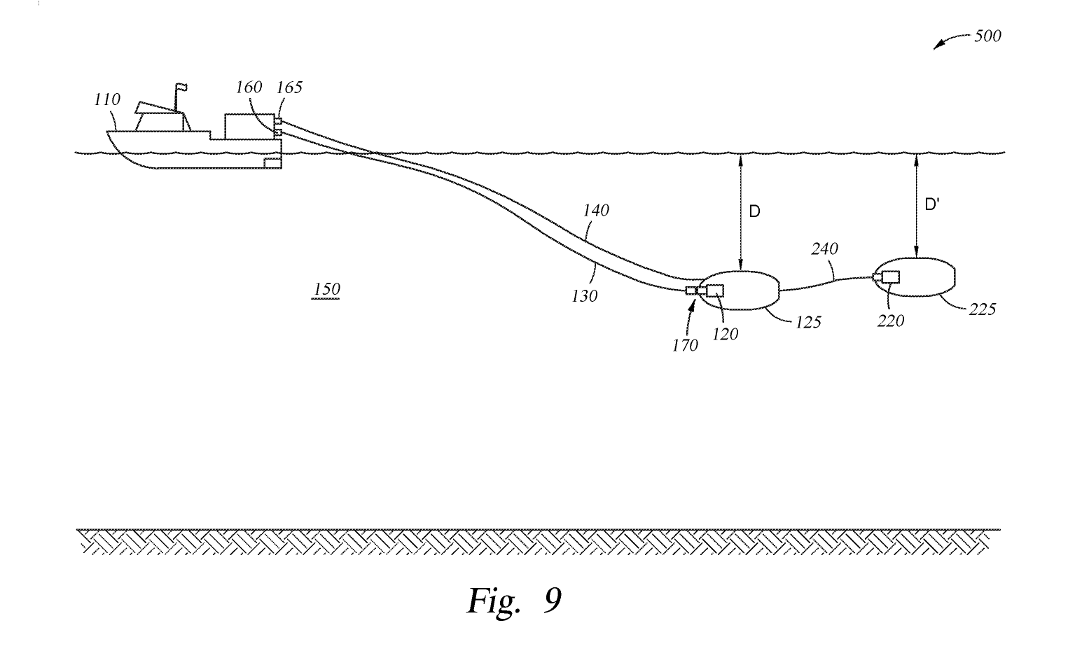

FIG. 9 illustrates marine vibrator assembly 500. As illustrated, marine vibrator assembly 500 is configured similarly to marine vibrator assembly 100. However, in addition to vibrational source 120, marine vibrator assembly 500 also includes aft vibrational source 220. The vibrational source 120 and the aft vibrational source 220 may have the same or different internal volumes and/or structures. Aft vibrational source 220 may be contained in aft housing 225. In some embodiments (not illustrated), aft housing 225 may include two, three, four or more aft vibrational sources 220. Aft housing 225 may contain aft vibrational source 220 by at least partially surrounding aft vibrational source 220. An umbilical 240 may couple vibrational source 120 to aft vibrational source 220. For example, umbilical 240 may provide electrical, optical, hydraulic, and/or other communication channels between vibrational source 120 and aft vibrational source 220. Umbilical 240 may facilitate transmission of sensor data and/or control signals between vibrational source 120 and aft vibrational source 220. Umbilical 240 may additionally provide gas communication between vibrational source 120 and aft vibrational source 220. In some embodiments (not illustrated), umbilical 240 may be coupled to vibrational source 220 with a releasable coupling. As illustrated, survey vessel 110 tows vibrational source 120 and aft vibrational source 220 through body of water 150 at a depths D and D′, respectively.

In some embodiments, the marine vibrator assembly 500 may include one or more pressure sensors. For example, pressure sensors may measure the internal pressure of vibrational source 120, the internal pressure of aft vibrational source 220, the external pressure on vibrational source 120, and/or the external pressure on aft vibrational source 220. In some embodiments, the marine vibrator assembly 500 may include one or more gas flow regulators which may be paired with a pump or pair of pumps. For example, gas flow regulators may regulate gas flow between hose 130 and vibrational source 120, and/or between vibrational source 120 and vibrational source 220. In some embodiments, a gas flow regulator may be responsive to measurements made by one or more of the pressure sensors. For example, a gas flow regulator between hose 130 and vibrational source 120 may allow gas to flow (or may pump gas) from hose 130 to the interior of vibrational source 120 until the internal pressure of the vibrational source 120 balances with the external pressure on the vibrational source 120, while another gas flow regulator between vibrational source 120 and aft vibrational source 220 may allow gas to flow (or may pump gas) from vibrational source 120 to the interior of aft vibrational source 220 until the internal pressure of the aft vibrational source 220 balances with the external pressure on the aft vibrational source 220. As would be understood by one of ordinary skill in the art with the benefit of this disclosure, when depth D is about equal to depth D′, and when the internal volumes and structures of vibrational source 120 are about the same as those of aft vibrational source 220, the internal pressures may be about equal. In such instances, a gas flow regulator between vibrational source 120 and aft vibrational source 220 may not be utilized, and gas may flow freely between the vibrational sources.

In accordance with a number of embodiments of the present disclosure, a geophysical data product may be produced. The geophysical data product may include, for example, vibrational source depth, vibrational source frequency(s), internal pressure of the vibrational source, external pressure on the vibrational source, gas flow data, temperature data, and seismic data gathered from actuation of the vibrational source. Geophysical data, such as data previously collected by seismic sensors, electromagnetic sensors, depth sensors, location sensors, etc., may be obtained (e.g., retrieved from a data library) and may be recorded on a non-transitory, tangible computer-readable medium. The geophysical data product may be produced by processing the geophysical data offshore (i.e. by equipment on a vessel) or onshore (i.e. at a facility on land) either within the United States or in another country. If the geophysical data product is produced offshore or in another country, it may be imported onshore to a facility in the United States. In some instances, once onshore in the United States, geophysical analysis, including further data processing, may be performed on the geophysical data product. In some instances, geophysical analysis may be performed on the geophysical data product offshore.

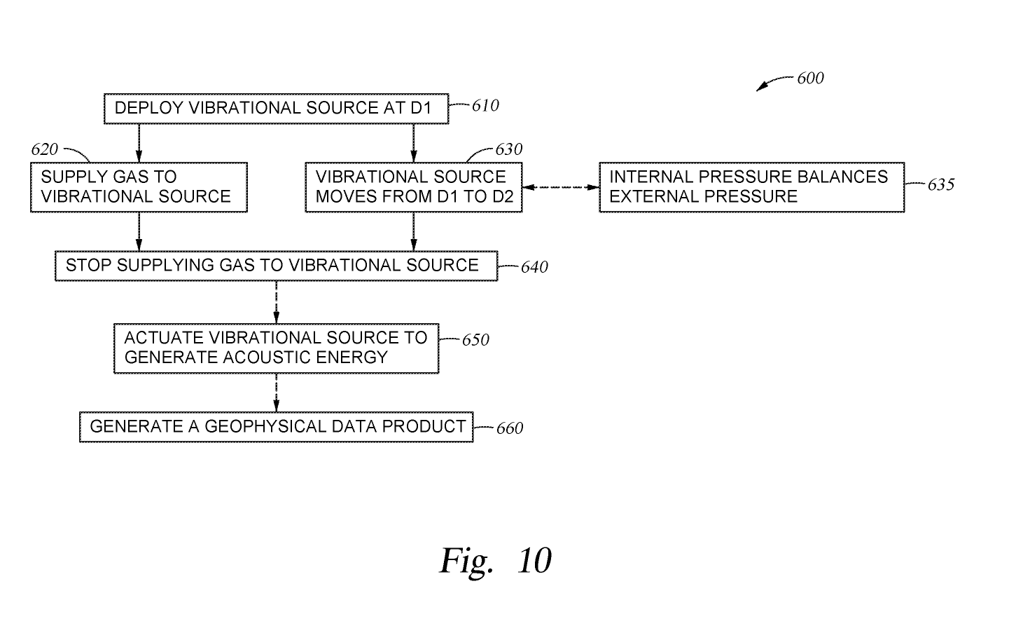

A method 600 of operating a marine vibrator assembly is illustrated in FIG. 10. The method begins at 610 by deploying a vibrational source at depth D₁. In some embodiments, the internal pressure of the vibrational source balances the external pressure on the vibrational source at depth D₁. The method continues at 620 by supplying gas to the vibrational source. Concurrently, at 630 the vibrational source moves from depth D₁ to a deeper depth D₂. In some embodiments, the internal pressure of the vibrational source balances the external pressure on the vibrational source at depth D₂. Optionally, at 635 the internal pressure of the vibrational source balances the external pressure on the vibrational source while the vibrational source moves from depth D₁ to depth D₂. The method continues at 640 by stopping the supplying gas to the vibrational source. Optionally, the method continues at 650 by actuating the vibrational source to generate acoustic energy as part of a marine survey. Optionally, the method continues at 660 by generating a geophysical data product.

In an embodiment, a marine vibrator assembly includes a vibrational source; a hose connectable between the vibrational source and a gas source; and a releasable coupling between the hose and the vibrational source.

In one or more embodiments described herein, a marine vibrator assembly further includes one or more additional vibrational sources.

In one or more embodiments described herein, a marine vibrator assembly further includes a manifold providing a gas coupling between at least two of the vibrational sources.

In one or more embodiments described herein, a marine vibrator assembly further includes a releasable coupling between the hose and the manifold.

In one or more embodiments described herein, a marine vibrator assembly further includes a releasable coupling between the manifold and the vibrational sources.

In one or more embodiments described herein, the gas source comprises at least one of a compressed gas source and a surface gas source.

In one or more embodiments described herein, the gas source comprises a compressed gas source, and the gas source is attached to the vibrational source.

In one or more embodiments described herein, a marine vibrator assembly further includes a gas reservoir attached to the vibrational source and configured to both receive gas from the vibrational source and supply gas to the vibrational source.

In one or more embodiments described herein, a marine vibrator assembly further includes a gas flow regulator between the hose and the vibrational source.

In one or more embodiments described herein, a marine vibrator assembly further includes a pressure sensor configured to measure at least one of an internal pressure of the vibrational source and an external pressure on the vibrational source.

In one or more embodiments described herein, the gas flow regulator is responsive to measurements from the pressure sensor.

In one or more embodiments described herein, a marine vibrator assembly further includes an aft vibrational source; and an umbilical between the vibrational source and the aft vibrational source.

In one or more embodiments described herein, a marine vibrator assembly further includes an aft compressed gas source attached to the aft vibrational source.

In one or more embodiments described herein, a marine vibrator assembly further includes a gas flow regulator between the hose and the vibrational source; a pressure sensor configured to measure at least one of an internal pressure of the vibrational source and an external pressure on the vibrational source; an aft gas flow regulator between the umbilical and the aft vibrational source; and an aft pressure sensor configured to measure at least one of an internal pressure of the aft vibrational source and an external pressure on the aft vibrational source.

In one or more embodiments described herein, the gas flow regulator is responsive to measurements from the pressure sensor; and the aft gas flow regulator is responsive to measurements from the aft pressure sensor.

In one or more embodiments described herein, a marine vibrator assembly further includes at least one of a survey vessel and an autonomous underwater vehicle, for towing the vibrational source through a body of water.

In one or more embodiments described herein, the vibrational source is a very low frequency source.

In an embodiment, a method of operating a marine vibrator assembly includes deploying a vibrational source into a body of water at a first depth, wherein an internal pressure of the vibrational source balances an external pressure on the vibrational source at the first depth; supplying gas at a flow rate to an interior of the vibrational source from a gas source as the vibrational source moves from the first depth to a second depth, wherein the internal pressure of the vibrational source balances the external pressure on the vibrational source at the second depth; stopping the supplying the gas from the gas source.

In one or more embodiments described herein, the internal pressure of the vibrational source balances the external pressure on the vibrational source while the vibrational source moves from the first depth to the second depth.

In one or more embodiments described herein, the second depth is at least 50 meters.

In one or more embodiments described herein, the flow rate is constant as the vibrational source moves from the first depth to the second depth.

In one or more embodiments described herein, a method of operating a marine vibrator assembly further includes after the stopping the supplying the gas from the gas source, supplying gas to the interior of the vibrational source from a gas reservoir attached to the vibrational source, wherein the gas reservoir is configured to both receive gas from the vibrational source and supply gas to the vibrational source.

In one or more embodiments described herein, the stopping the supplying the gas comprises releasing a hose connectable between the vibrational source and the gas source.

In one or more embodiments described herein, the gas source comprises at least one of a compressed gas source and a surface gas source.

In one or more embodiments described herein, the gas source comprises a surface gas source; the stopping the supplying the gas comprises releasing a hose connectable between the vibrational source and the gas source; and the method further comprises retrieving the hose from the body of water.

In one or more embodiments described herein, a method of operating a marine vibrator assembly further includes towing the vibrational source through the body of water.

In one or more embodiments described herein, a towing speed before the retrieving the hose from the body of water is less than the towing speed after the retrieving the hose from the body of water.

In one or more embodiments described herein, the towing the vibrational source is done by either a survey vessel or an autonomous underwater vehicle.

In one or more embodiments described herein, a method of operating a marine vibrator assembly further includes measuring the internal pressure of the vibrational source; and adjusting the flow rate in response to the measuring the internal pressure.

In one or more embodiments described herein, a method of operating a marine vibrator assembly further includes measuring the internal pressure of the vibrational source; and removing gas from the interior of the vibrational source in response to the measuring the internal pressure.

In one or more embodiments described herein, a method of operating a marine vibrator assembly further includes deploying one or more additional vibrational sources into the body of water; and providing a gas coupling between at least two of the vibrational sources with a manifold.

In one or more embodiments described herein, the stopping the supplying the gas comprises releasing a hose connectable between the gas source and the manifold.

In one or more embodiments described herein, a method of operating a marine vibrator assembly further includes deploying one or more additional vibrational sources into the body of water, wherein, when the vibrational source is at the second depth, at least one of the additional vibrational sources is at a third depth different from the second depth.

In one or more embodiments described herein, a method of operating a marine vibrator assembly further includes deploying an aft vibrational source into the body of water; supplying gas to the aft vibrational source through an umbilical between the vibrational source and the aft vibrational source.

In one or more embodiments described herein, when the vibrational source is at the second depth, the aft vibrational source is at a third depth different from the second depth.

In one or more embodiments described herein, the vibrational source is a very low frequency source.

In one or more embodiments described herein, a method of operating a marine vibrator assembly further includes actuating the vibrational source to generate acoustic energy.

In an embodiment, a method of generating a geophysical data product includes operating a marine vibrator assembly according to one or more embodiments described herein; actuating the vibrational source to generate acoustic energy; obtaining geophysical data; and processing the geophysical data to produce the geophysical data product.

In one or more embodiments described herein, the method of generating a geophysical data product further includes recording the geophysical data product on a non-transitory, tangible computer-readable medium suitable for importing onshore.

In one or more embodiments described herein, the method of generating a geophysical data product further includes performing geophysical analysis onshore on the geophysical data product.

While the foregoing is directed to embodiments of the present invention, other and further embodiments of the invention may be devised without departing from the basic scope thereof, and the scope thereof is determined by the claims that follow.

1. A marine vibrator assembly comprising:
a vibrational source;
a hose connectable between the vibrational source and a gas source, wherein the gas source comprises at least one of a compressed gas source and a surface gas source; and
a releasable coupling between the hose and the vibrational source.

2. The marine vibrator assembly of claim 1, further comprising one or more additional vibrational sources.

3. The marine vibrator assembly of claim 2, further comprising a manifold providing a gas coupling between at least two of the vibrational sources.

4. The marine vibrator assembly of claim 3, wherein the releasable coupling is between the hose and the manifold.

5. The marine vibrator assembly of claim 3, wherein the releasable coupling is between the manifold and the vibrational sources.

6. The marine vibrator assembly of claim 1, further comprising a gas reservoir attached to the vibrational source and configured to both receive gas from the vibrational source and supply gas to the vibrational source.

7. The marine vibrator assembly of claim 1, further comprising:
a gas flow regulator between the hose and the vibrational source; and
a pressure sensor configured to measure at least one of an internal pressure of the vibrational source and an external pressure on the vibrational source.

8. The marine vibrator assembly of claim 7, wherein the gas flow regulator is responsive to measurements from the pressure sensor.

9. The marine vibrator assembly of claim 1, further comprising:
an aft vibrational source; and
an umbilical between the vibrational source and the aft vibrational source.

10. The marine vibrator assembly of claim 9, further comprising an aft compressed gas source attached to the aft vibrational source.

11. The marine vibrator assembly of claim 9, further comprising:
a gas flow regulator between the hose and the vibrational source;
a pressure sensor configured to measure at least one of an internal pressure of the vibrational source and an external pressure on the vibrational source;
an aft gas flow regulator between the umbilical and the aft vibrational source; and
an aft pressure sensor configured to measure at least one of an internal pressure of the aft vibrational source and an external pressure on the aft vibrational source.

12. The marine vibrator assembly of claim 11, wherein:
the gas flow regulator is responsive to measurements from the pressure sensor; and
the aft gas flow regulator is responsive to measurements from the aft pressure sensor.

13. The marine vibrator assembly of claim 1, wherein the vibrational source is a very low frequency source.

14. A method of operating a marine vibrator assembly comprising:
deploying a vibrational source into a body of water at a first depth, wherein an internal pressure of the vibrational source balances an external pressure on the vibrational source at the first depth;
supplying gas at a flow rate to an interior of the vibrational source from a gas source as the vibrational source moves from the first depth to a second depth, wherein the internal pressure of the vibrational source balances the external pressure on the vibrational source at the second depth;
stopping the supplying the gas from the gas source.

15. The method of claim 14, wherein the internal pressure of the vibrational source balances the external pressure on the vibrational source while the vibrational source moves from the first depth to the second depth.

16. The method of claim 14, wherein the second depth is at least 50 meters.

17. The method of claim 14, wherein the flow rate is constant as the vibrational source moves from the first depth to the second depth.

18. The method of claim 14, further comprising, after the stopping the supplying the gas from the gas source, supplying gas to the interior of the vibrational source from a gas reservoir attached to the vibrational source, wherein the gas reservoir is configured to both receive gas from the vibrational source and supply gas to the vibrational source.

19. The method of claim 14, wherein the stopping the supplying the gas comprises releasing a hose connectable between the vibrational source and the gas source.

20. The method of claim 14, wherein the gas source comprises at least one of a compressed gas source and a surface gas source.

21. The method of claim 14, wherein:
the gas source comprises a surface gas source;
the stopping the supplying the gas comprises releasing a hose connectable between the vibrational source and the gas source; and
the method further comprises retrieving the hose from the body of water.

22. The method of claim 21, further comprising towing the vibrational source through the body of water, wherein a towing speed before the retrieving the hose from the body of water is less than the towing speed after the retrieving the hose from the body of water.

23. The method of claim 14, further comprising:
measuring the internal pressure of the vibrational source; and
adjusting the flow rate in response to the measuring the internal pressure.

24. The method of claim 14, further comprising:
measuring the internal pressure of the vibrational source; and
removing gas from the interior of the vibrational source in response to the measuring the internal pressure.

25. The method of claim 14, further comprising:
deploying one or more additional vibrational sources into the body of water; and
providing a gas coupling between at least two of the vibrational sources with a manifold, wherein the stopping the supplying the gas comprises releasing a hose connectable between the gas source and the manifold.

26. The method of claim 14, further comprising deploying one or more additional vibrational sources into the body of water, wherein, when the vibrational source is at the second depth, at least one of the additional vibrational sources is at a third depth different from the second depth.

27. The method of claim 14, wherein the vibrational source is a very low frequency source.

28. The method of claim 14, further comprising actuating the vibrational source to generate acoustic energy.

29. A method of manufacturing a geophysical data product comprising:
operating the marine vibrator assembly according to the method of claim 14;
actuating the vibrational source to generate acoustic energy;
obtaining geophysical data; and
processing the geophysical data to produce the geophysical data product.

30. The method of claim 29, further comprising:
recording the geophysical data product on a non-transitory, tangible computer-readable medium suitable for importing onshore; and
performing geophysical analysis onshore on the geophysical data product.
